(19) United States
(12) Patent Application Publication
(10) Pub. No.: US 2009/0262079 A1
(43) Pub. Date: Oct. 22, 2009

(54) Electronic Device in the Form of a Hands-Free Telephone System and/or a Navigation Device

(76) Inventors: Henryk BURY, Loehne (DE); Feliks ROZAK, Pzeszow (PL)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/425,588

(22) Filed: Apr. 17, 2009

(30) Foreign Application Priority Data
Apr. 22, 2008 (DE) 10 2008 020 551.6

(51) Int. Cl. G06F 3/02

(52) U.S. Cl. 345/169

(57) ABSTRACT

An electronic device in the form of a hands-free telephone system and/or a navigation device, comprising a housing having a base part (1) that is hinged to a display part (3) such that it lies on the base part (1) when folded so that the base part (1) and the display part (3) each form an outer side (4, 5), and a display (7) is located on the outer side (5) of the display part (3), said device offering a wider range of uses, characterized in that the display part (3) is mounted so as to pivot approximately 180° away from the base part (1), and a complete alphanumeric keyboard (6) is attached to the outer side (4) of the base part (1). In particular, the electronic device designed in this manner is preferably set up to be wirelessly connected to a data network (Internet).

The invention relates to an electronic device in the form of a hands-free telephone system and/or a navigation device, comprising a housing having a base part to which a display part is hinged such that it lies on the base part when folded so that the base part and the display part each have an outer side, and a display is located on the outer side of the display part.

Such a device is marketed under the name of “BURY CV 9040.” The base part is designed to fasten the device, preferably with a fastening frame, and can be fastened in a motor vehicle to the dashboard, sun visor, rearview mirror, the windshield, etc. The display part is mounted on the base part and can pivot a maximum of 90°. When it is fastened to a base essentially below head height such as the top of a dashboard, the display of the display part extends upward from the base part, whereas when it is fixed to the sun visor, windshield, rearview mirror, etc., it preferably extends downward. The device is designed with a corresponding position sensor that detects the alignment of the display part and automatically adapts the display so that the cited mounting options easily result. The known device is designed as a hands-free telephone system that communicates with a cell phone by means of a wireless short-range transmission device based on the Bluetooth standard and therefore makes it possible to carry on a telephone conversation via a speaker and microphone installed in this device. The device can be operated by means of a voice control or by a display designed as a touchscreen on the outer side of the display part. The device is provided with an independent power supply from a rechargeable battery.

The object of the present invention is to design such a device to increase its uses.

This problem is solved according to the invention by an electronic device of the above-mentioned kind in that the display part is mounted so as to be pivotable approximately 180° away from the base part, and a complete alphanumeric keyboard is affixed to the outer side of the base part.

Whereas the foldable design and position sensor of the known electronic device allow it to be fastened in different ways with the display remaining clearly visible on the outer side of the display part, the device according to the invention can be used in a completely different manner because the display part can be folded approximately 180° away from the base part; consequently, since the keyboard is arranged on the outer side of the base part, the keyboard can be positioned below the display on the outer side of the display part, and the device can be operated with a complete keyboard below the display. Accordingly, the electronic device can be easily used like a laptop, for example for entering schedule information, etc. when it is removed from its fastened position, for example in a motor vehicle, and used on a normal base such as a desk.

With the arrangement according to the invention, the device unusually bears a keyboard on the outer side of the base part so that the keyboard lies on the outer side when the device is folded. With laptops or similar devices such as the “Communicator” device by the telephone manufacturer Nokia, the keyboard is always on the inside of the base part of a foldable device and is therefore covered when the device is folded.

The embodiment according to the invention contrastingly enables the electronic device to be used like a laptop and as display device for a hands-free system or a navigation device by means of an attachment of the base part suitable for a motor vehicle.

The alphanumeric keyboard is preferably designed as a computer keyboard, especially a compact keyboard.

The design of the electronic device according to the invention is particularly advantageous when it is set up to wirelessly connect to a data network such as the Internet. With the complete keyboard, navigating and working with the data network is particularly easy and not subject to restrictions that, for example, result with an Internet- capable cell phone without the keyboard for reasons of space. When a cell phone is equipped with a keyboard (Nokia Communicator), there are substantial acceptance problems due to the required size of the cell phone.

The electronic device according to the invention is also preferably equipped with a wireless close-range transmission system for data and/or audio signals, especially based on the Bluetooth standard.

In a preferred embodiment of the device according to the invention, the display part can be unfolded up to a stop by approximately 180° relative to the base part. The stop provides a stable connection between the display part and base part in the direction of unfolding. When, in a preferred embodiment, the display part is provided with a support hinged to the display part that can pivot away from the display and can rest on a supporting surface, the device can be placed on the supporting surface in a stable arrangement unfolded up to the stop and positioned at an angle by the pivoted support which substantially improves the visibility of the display and ease of use.

The invention will be further explained in the following with reference to exemplary embodiments shown in the drawings. The drawings show:

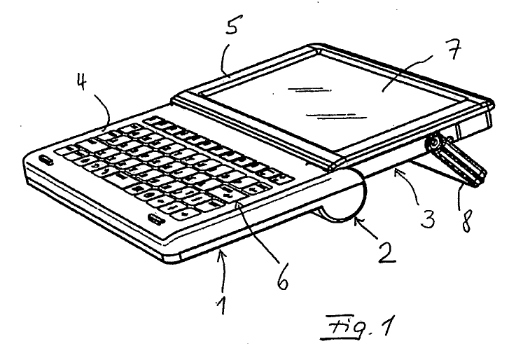

FIG. 1 A perspective view of an embodiment of the device according to the invention in unfolded position;

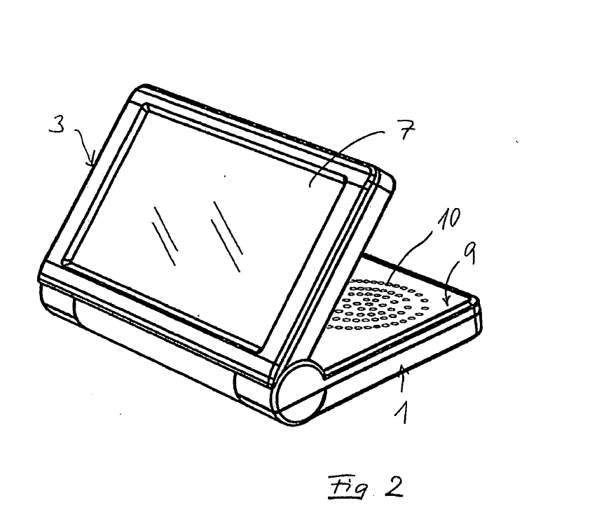

FIG. 2 A possible mounting position for the device according to the invention;

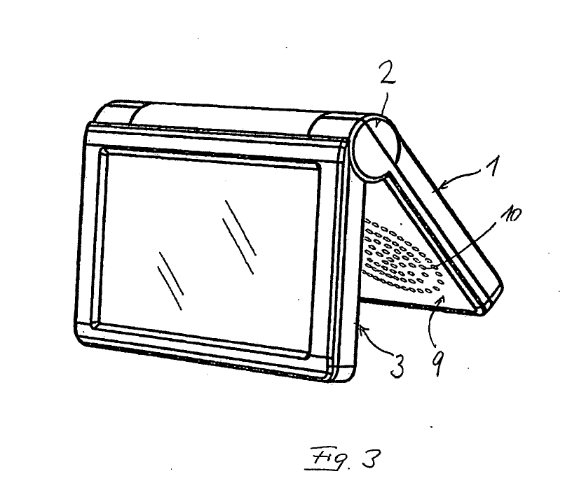

FIG. 3 A possible other mounting position for the device according to the invention;

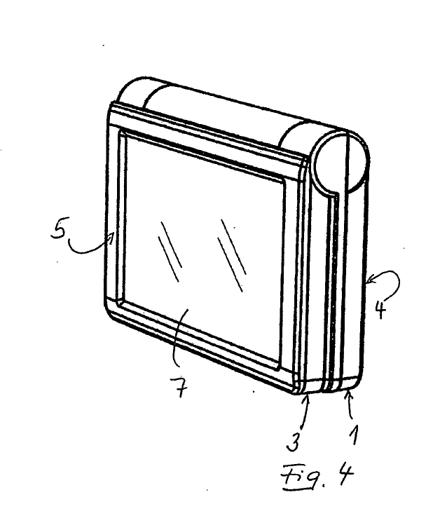

FIG. 4 The device according to FIG. 1 in a folded state for transport;

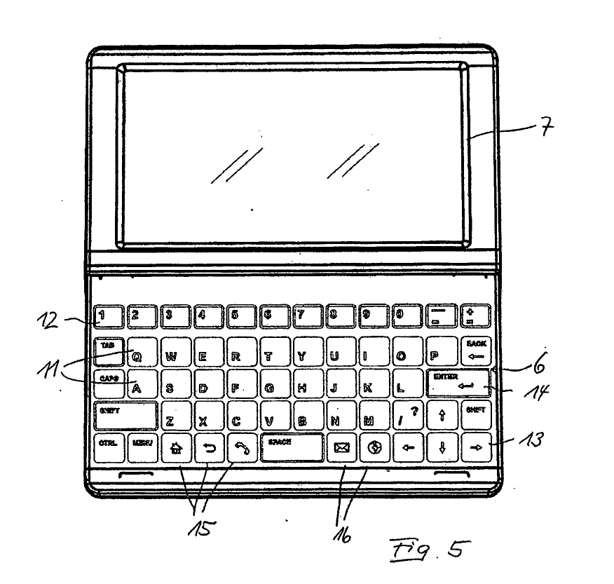

FIG. 5 A front view of the device from FIG. 1 with a display and keyboard;

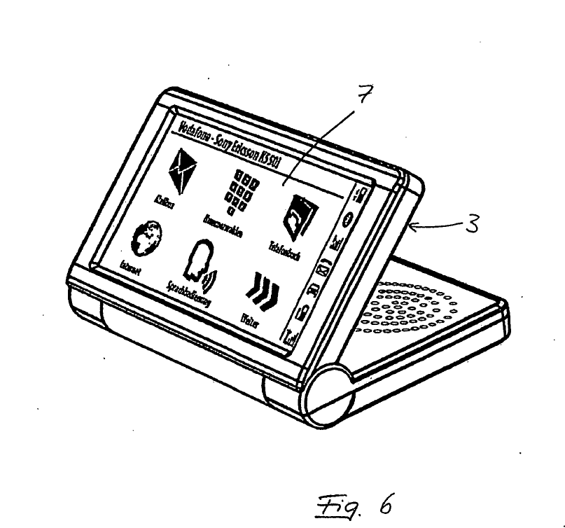

FIG. 6 A representation of the device from FIG. 2 with a display for touchscreen operation;

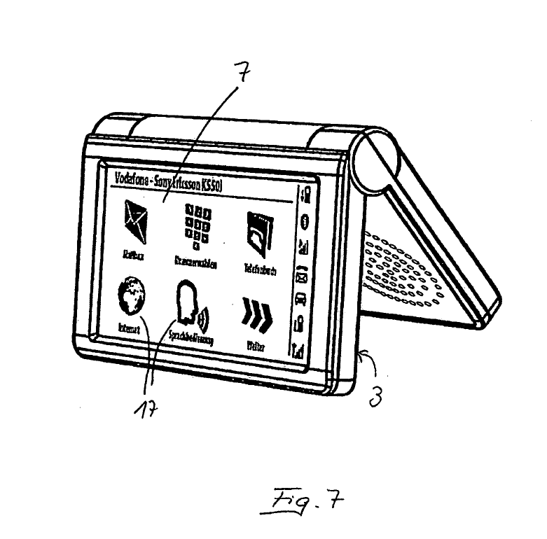

FIG. 7 A representation according to FIG. 6 of the device in the position from FIG. 3;

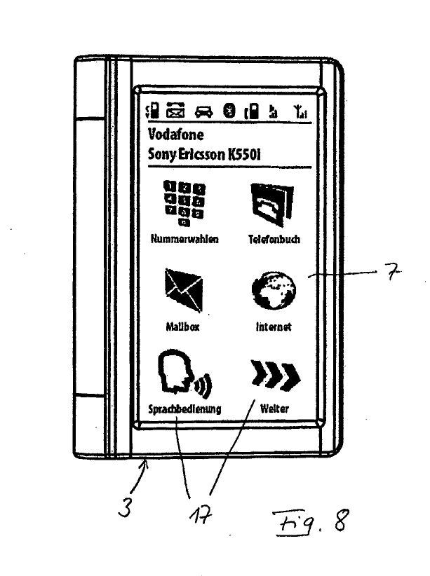

FIG. 8 A birds-eye view of the display when the device is positioned upright.

FIG. 1 shows that the device according to the invention has a base part 1 to which a display 3 is articulated via a hinge 2. The device is in a completely unfolded position in which the display part 3 is a flush extension of the base part 1, i.e., unfolded 180°. The device can be moved from the unfolded position shown in FIG. 1 into the folded position shown in FIG. 4 by folding the display part 3 in the representation in FIG. 1 in a clockwise direction (i.e., downward) against the base part 1. Accordingly, the outer sides 4, 5 of the base part 1 and the display part 3 can be seen in FIG. 1 with reference to the folded position shown in FIG. 4. On its outer side 4, the base part 1 has a keyboard 6 that, as will be further explained with reference to FIG. 5, is designed as a complete computer keyboard in the form of a conventional compact keyboard for a laptop. A large display 7 is on the outer side 5 of the display part 3.

To provide support on a base (not shown), a U-shaped arm extending across the display part 3 can be pivoted as a support 8 out of the plane of the display part 3 as shown in FIG. 1. The device can therefore be placed on a base without tipping, wherein the outer sides 4, 5 of the base part 1 and display part 3 rise approximately flush at an angle, which makes the keyboard 6 easy to use and the display 7 easy to read.

FIG. 1 illustrates a way to use the device according to the invention that does not correspond to typical use since the device is normally mounted in a motor vehicle, whereas FIG. 1 illustrates the usefulness of the device after it is removed from its fastened position in the motor vehicle.

FIG. 2 shows one possible arrangement of the device wherein the base part 1 is designed to be attached with a fastening device (not shown), for example in the form of a frame. The frame can be located on the surface of the dashboard of a motor vehicle that rises at an angle to produce a useful position for the display part 3 as shown in FIG. 2. The display part 3 extends upward from the base part 1 such that it enables the driver of the vehicle to have a good view of the display 7 from above.

FIG. 2 shows that there is a loudspeaker cover 10 with a plurality of holes on the inside 9 of the base part 1 that makes it easier to broadcast sound from a speaker in the base part 1.

In contrast, FIG. 3 shows an arrangement of the device according to the invention in which the base part 1 is in a position that results from fastening the base part 1 to a sun visor or to an angled front windshield of the motor vehicle. The unfolded display part 3 accordingly extends downward from the base part at a sharp angle from the hinge 2, i.e., with the device in a flipped position from that shown in FIG. 2.

FIG. 4 shows the device in a folded state after having been removed from the motor vehicle so that it can be easily transported.

Since the keyboard 6 is on the outer side 4 of the base part 1, the keyboard 6 faces outward when the device is folded.

FIG. 5 shows that the device can be used completely like a laptop when it his unfolded as in FIG. 1 since the keyboard is usefully designed as a compact laptop keyboard. In addition to keys 11 for the individual letters, keys 12 for numbers are located in a top row. Navigation keys 13 (up, down, left, right) allow the cursor to be moved and are located below a larger “Enter” key 14. The keyboard is supplemented by the usual function keys 15 found on laptop keyboards, and keys 16 are also preferably provided on the device according to the invention that relate to Internet access since the device according to the invention is preferably provided with access to a data network, especially the Internet.

FIG. 6 and 7 correspond to the representations in FIG. 2 and 3; however, function fields 17 are shown on the display 7 since the display 7 is preferably designed as a touchscreen and correspondingly allows the functions to be selected by touching the display 7.

FIG. 6 and 7 show that the representation of the function fields 17 on the display 7 is adapted to the respective position of the display part 3 in that the display part 3 is provided with a position sensor (not shown) that recognizes the alignment of the display part 3 relative to gravity and subsequently automatically adjusts the presentation of the function fields 17.

FIG. 8 shows that the function fields 17 can be presented on the display 7 in a “portrait” format when the display part 8 is held upright like a notebook.

Designing the keyboard 6 according to the invention on the outer side 4 of the base part 1 allows the device according to the invention to be used in many ways both when installed in different positions and when removed from the installation holder as a transportable device that enables it to be used like a laptop.

In addition to a speaker, the base part 1 usefully contains a battery that can be rechargeable. Since the display part 3 faces the user when installed, a microphone for a hands-free system is preferably provided in the display part 3. The electrical connection between the display part 3 and base part 1 is realized by a corresponding contact in the hinge 2.

It is of course possible to charge the rechargeable battery with a charging cable that, for example, can be contacted in a cigarette lighter of the motor vehicle. It is however also possible to equip the device with solar cells to charge the rechargeable battery.

Instead of operating the device by means of function fields 17 of the display 7 designed as a touchscreen, a normal display 7 can be used when the display part 3 is provided with corresponding operating keys.

1. An electronic device in the form of a hands-free telephone system and/or a navigation device, comprising a housing having a base part (1) that is designed to be fastened with a fastening device in a vehicle and to that a display part (3) is pivotably mounted such that it lies on the base part (1) when folded so that the base part (1) and the display part (3) each form an outer side (4, 5), and a display (7) is located on the outer side (5) of the display part (3), characterized in that the display part (3) is mounted to allow a pivoting of approximately 180° away from the base part (1), and a complete alphanumeric keyboard (6) is attached to the outer side (4) of the base part (1).

2. Electronic device according to claim 1, characterized in that the alphanumeric keyboard (6) is designed as a computer keyboard.

3. Electronic device according to claim 2, characterized in that the alphanumeric keyboard (6) is a compact keyboard.

4. Electronic device according to claim 1, characterized in that it is set up to be wirelessly connected to a data network.

5. Electronic device according to claim 1, characterized in that it is equipped with a wireless close-range transmission device for data and/or audio signals.

6. Electronic device according to claim 1, characterized in that the display part (3) can be unfolded up to a stop approximately 180° relative to the base part (1).

7. Electronic device according to claim 1, characterized in that the display part (3) is provided with a support (8) hinged to the display part (3) that can swing away from the display (7) to be supported against a supporting surface.
